(19) United States
(12) Patent Application Publication
(10) Pub. No.: US 2021/0117926 A1
(43) Pub. Date: Apr. 22, 2021

(54) CATCH-UP POLL-CALENDAR VIEW

(71) Applicant: Microsoft Technology Licensing, LLC, Redmond, WA (US)

(72) Inventors: Jason Thomas FAULKNER, Seattle, WA (US); Tiphanie LAU, Seattle, WA (US); Rajiv RAMAIAH, Bellevue, WA (US); Sonu ARORA, Kirkland, WA (US)

(73) Assignee: Microsoft Technology Licensing, LLC, Redmond, WA (US)

(21) Appl. No.: 16/655,661

(22) Filed: Oct. 17, 2019

(51) Int. Cl. G06Q 10/10; H04L 12/58

(52) U.S. Cl. CPC G06Q 10/1093; H04L 51/046

(57) ABSTRACT

A system and method of displaying a graphical element associated with a poll in a calendar view is provided. Initially, a polling system may determine that a response from a user has not been provided to a poll event. Accordingly, poll information associated with the poll event may be received, where the poll information may indicate a start and end time of a poll. A time slot based on the poll information may be determined which may cause a graphical element for the poll event to be displayed in the calendar view of the user at the determined time slot. In some instances, the graphical element may be provided when a user has missed or otherwise has not provided input into a poll event.

### BACKGROUND

Communication environments allow users of devices to communicate across a computer network such as the internet. Communication events which can be established include voice calls, video calls, instant messaging, voice mail, file transfer and others. It is known for a user of an instant messaging communication session to create a poll and share the poll with other users of the instant messaging communication session during the session to receive their feedback. The user creating the poll specifies each poll option manually. For example, a user creating a poll to enable a group of friends to decide where to go for lunch finds out the names of nearby restaurants, enters them manually as poll options and shares the poll with the rest of the group. However, manually placed objects designed to collect and report data at a one dimensional level do not take into account poll activity data across environments and groups do not extend user engagement beyond the immediate poll creation and response.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for inserting a graphical element associated with a poll into a calendar view and/or calendar application such that a user may view the poll in conjunction with one or more other events in their schedule. In some instances, the poll may be inserted into the user's calendar view and/or calendar application when the user has not responded to the assigned poll. Polls existing in context to chat and channel activity may be manually placed objects or bots designed to collect and report data at a first dimensional level. Poll bubbles however, encourage, engage, collect and expose poll activity data across environments and groups via improved and new multi-dimensional inputs, context, bubble personality and outputs, thereby allowing for group activity, location proximity, role activity, user inputs, data collection, machine pattern learning, intelligent agent suggestions, etc. to push to the top level of a user experience. By including polling activity across applications, systems, environments, and devices, the lifecycle of the group poll activity is better contextually exposed via the reach of poll bubble states across pre, during and post engagement activity and results including unique data input capture and output curation. Thus, for example, quick slider expression of depth of input, word cloud curation results, role based live activity results, suggestive poll content opportunities, pre curated polling options and suggestions, etc. may be made readily available to aid in decision making processes going forward. However, in instances where a user has not completed an intelligent poll bubble, a graphical element indicative of the poll bubble may be inserted into the user's calendar view and/or calendar application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates details of a conferencing, messaging, and collaboration system in accordance with the aspects a of the disclosure;

FIG. 2A depicts additional details of a first graphical user interface in accordance with examples of the present disclosure;

FIG. 2B depicts additional details of a second graphical user interface in accordance with examples of the present disclosure;

FIG. 2C depicts additional details of a third graphical user interface in accordance with examples of the present disclosure;

FIG. 2D depicts additional details of a fourth graphical user interface in accordance with examples of the present disclosure;

FIG. 2E depicts additional details of a fifth graphical user interface in accordance with examples of the present disclosure;

FIG. 2F depicts additional details of a sixth graphical user interface in accordance with examples of the present disclosure;

FIG. 2G depicts additional details of a seventh graphical user interface in accordance with examples of the present disclosure;

FIG. 2H depicts additional details of a eighth graphical user interface in accordance with examples of the present disclosure;

FIG. 2I depicts additional details of a ninth graphical user interface in accordance with examples of the present disclosure;

FIG. 2J depicts additional details of a tenth graphical user interface in accordance with examples of the present disclosure;

FIG. 2K depicts additional details of a eleventh graphical user interface in accordance with examples of the present disclosure;

FIG. 2L depicts additional details of a twelfth graphical user interface in accordance with examples of the present disclosure;

FIG. 2M depicts additional details of a thirteenth graphical user interface in accordance with examples of the present disclosure; and

FIG. 3 depicts details of the conferencing, messaging, and collaboration system in accordance with examples of the present disclosure;

FIG. 4 depicts additional details of the conferencing, messaging, and collaboration system in accordance with examples of the present disclosure;

FIG. 5 depicts details of one or more data structures in accordance with examples of the present disclosure;

FIG. 6 depicts details of a method for displaying a graphical element associated with a poll in a calendar view and/or calendar application in accordance with examples of the present disclosure;

FIG. 7 depicts details of a method for displaying a graphical element associated with a poll in a calendar view and/or calendar application in accordance with examples of the present disclosure;

FIG. 8 depicts details of a method for displaying a graphical element associated with a missed poll in a calendar view and/or calendar application in accordance with examples of the present disclosure;

FIG. 9 is a block diagram illustrating example physical components of a computing device with which aspects of the disclosure may be practiced;

FIG. 10A is a simplified block diagram of a computing device with which aspects of the present disclosure may be practiced;

FIG. 10B is another are simplified block diagram of a mobile computing device with which aspects of the present disclosure may be practiced; and

FIG. 11 is a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

As discussed above, in examples where polling may be utilized during events, integrating one or more polling features with one or more existing applications utilized by users, increases usability and provides at least one manner for obtaining user feedback. Moreover, for polls that may have been missed by a user, an indication of the poll may be inserted into a user's calendar view and/or calendar application such that the user can participate in the poll.

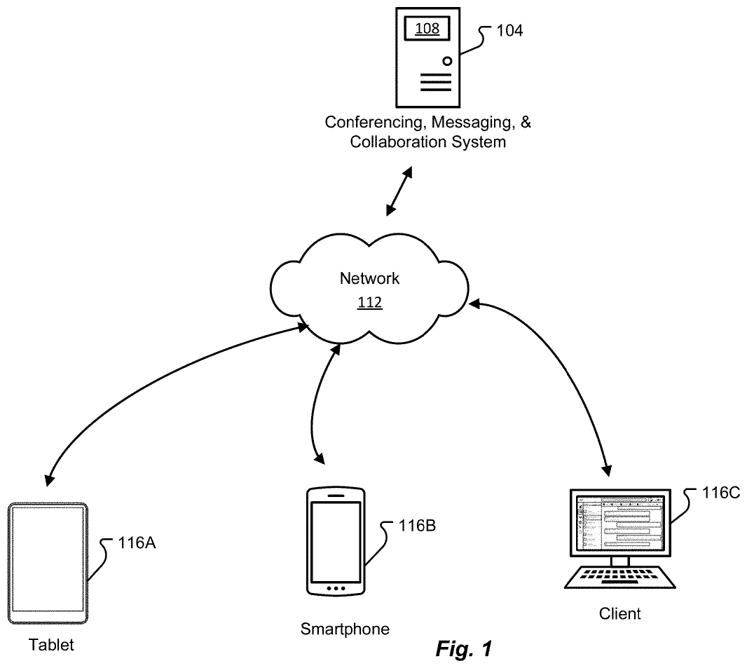

FIG. 1 depicts aspects of a messaging, conferencing, and collaboration system 104 in accordance with examples of the present disclosure. The messaging, conferencing, and collaboration system 104 may include a messaging, conferencing, and collaboration system 108; the messaging, conferencing, and collaboration application 108 may reside at a single device, such as a server of the messaging, conferencing, and collaboration system 104, or may be distributed amongst a plurality of servers and/or other devices for instance. In some examples, the conferencing, messaging, and collaboration system 108 may reside in a cloud environment and may be accessible via one or more networks 112 by one or more devices 116A-116C. In some examples, the client device 116A-116C may correspond to a tablet device 116A, a smartphone 116B and/or a tablet 116C. As another non-limiting example, at least one client device 116A-116C may be any device configured to allow a user to use an application such as, for example, a smartphone, a tablet computer, a desktop computer, laptop computer device, gaming devices, media devices, smart televisions, multimedia cable/television boxes, smart phone accessory devices, industrial machinery, home appliances, thermostats, tablet accessory devices, personal digital assistants (PDAs), or other Internet of Things (IOT) devices.

As indicated above, one or more devices 116A-116C may interact with the conferencing, messaging, and collaboration system 104. In some instances, a collaboration application, such as Microsoft Outlook or Microsoft Teams may be installed or otherwise executed at one or more of the devices 116A-116C. Alternatively, or in addition, a browser or other network/web accessible application may interact with the messaging, conferencing, and collaboration system 104 via the network 112.

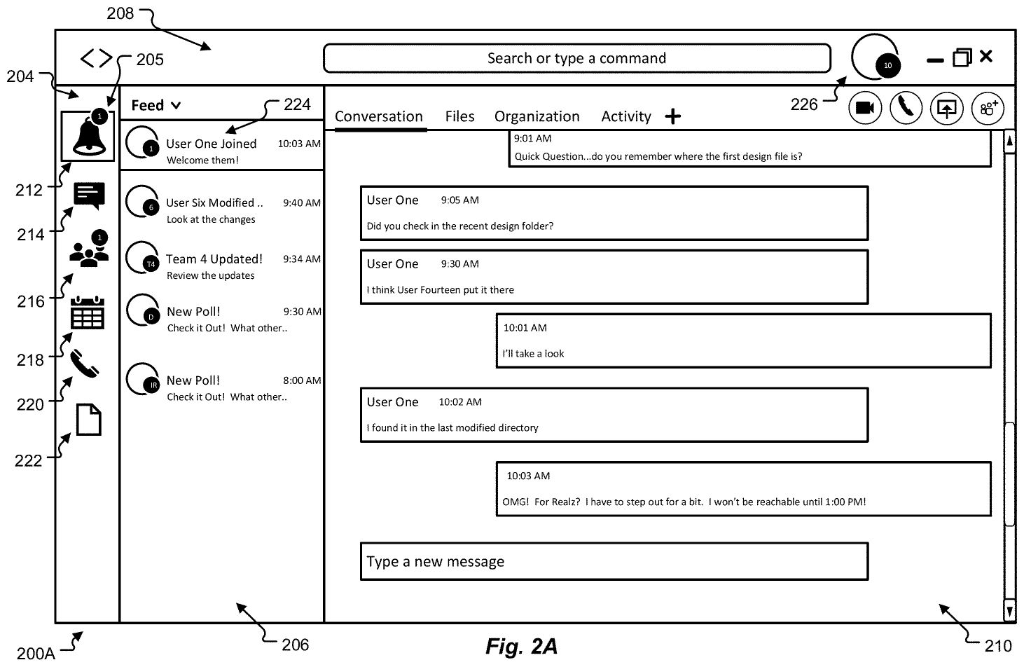

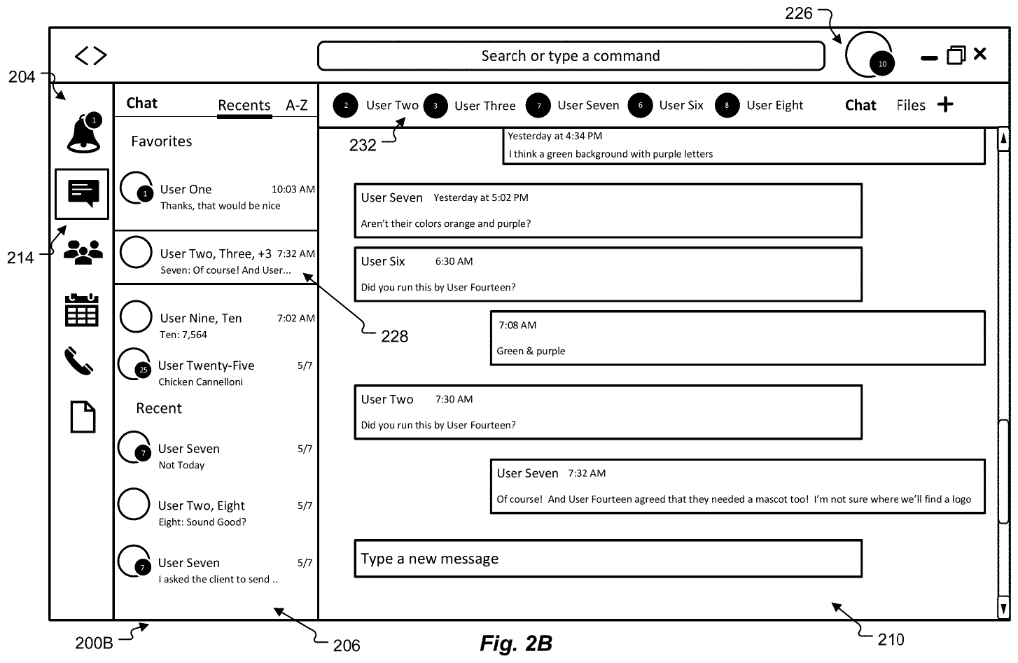

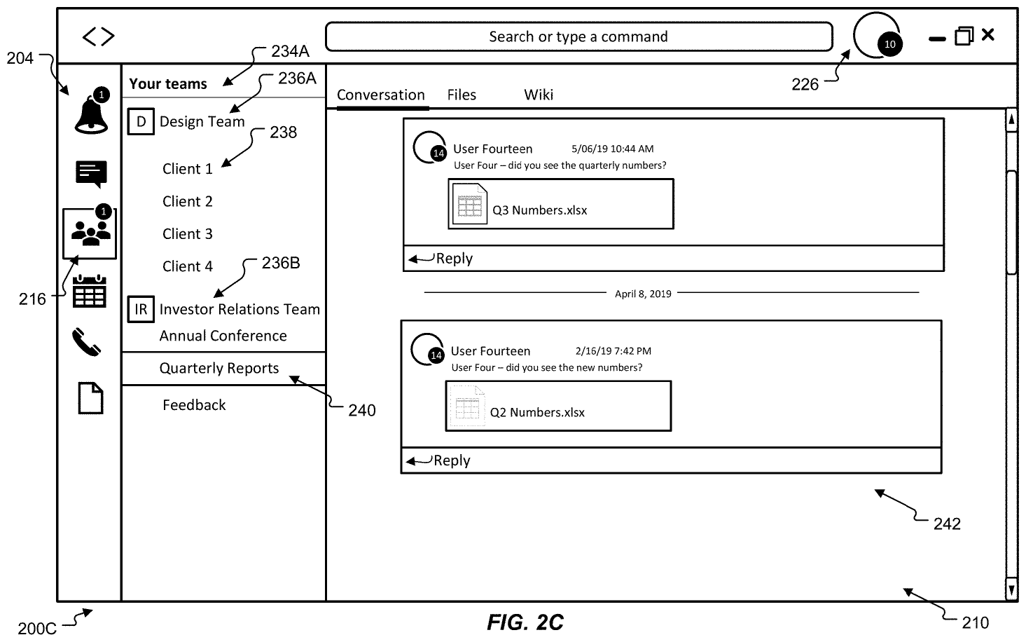

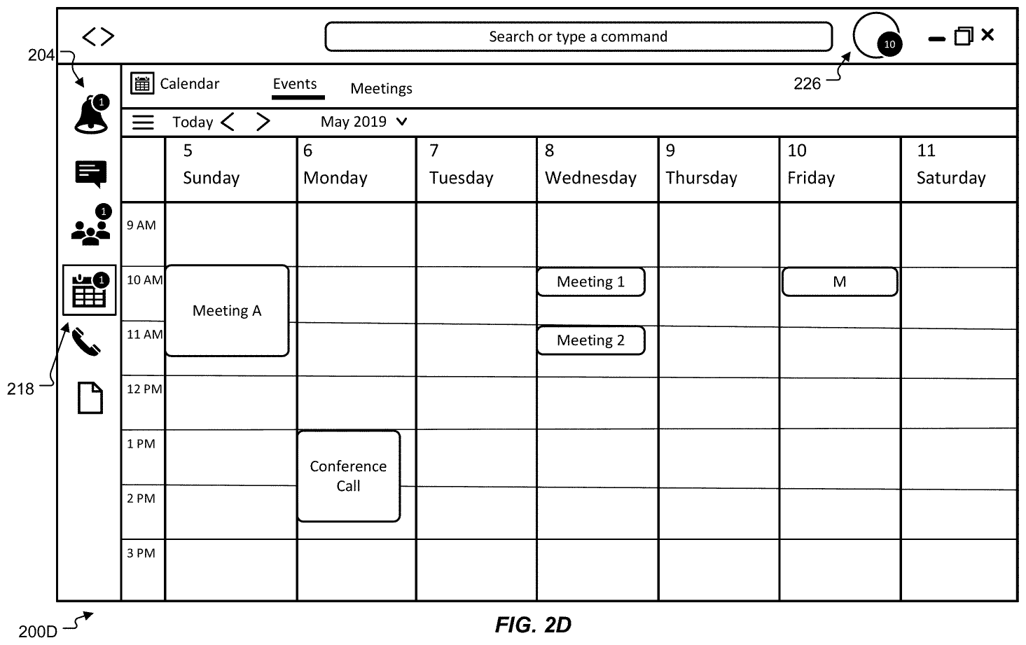

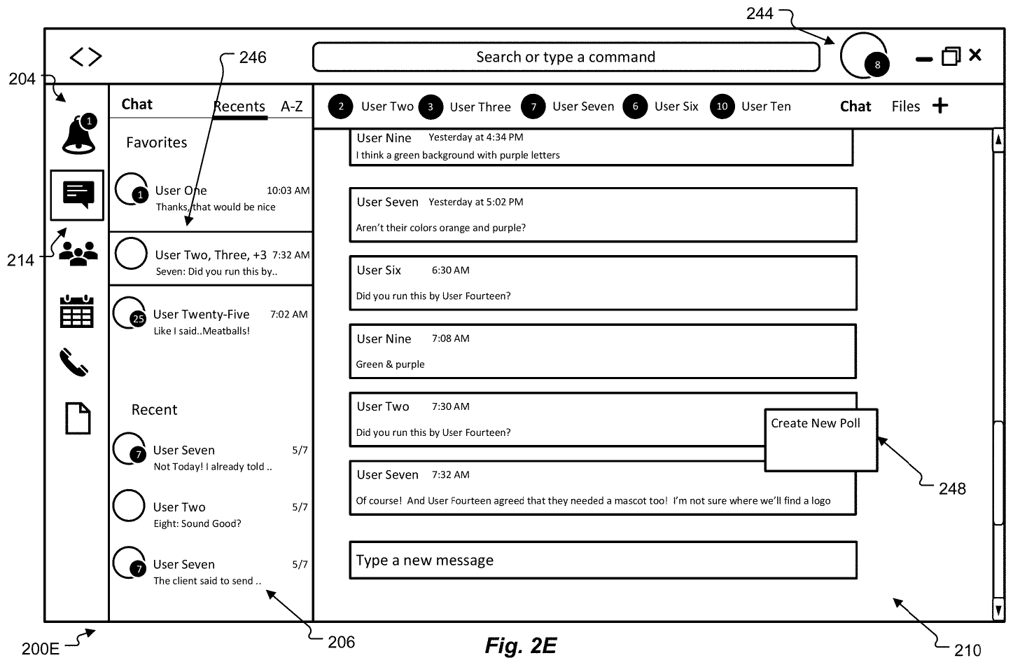

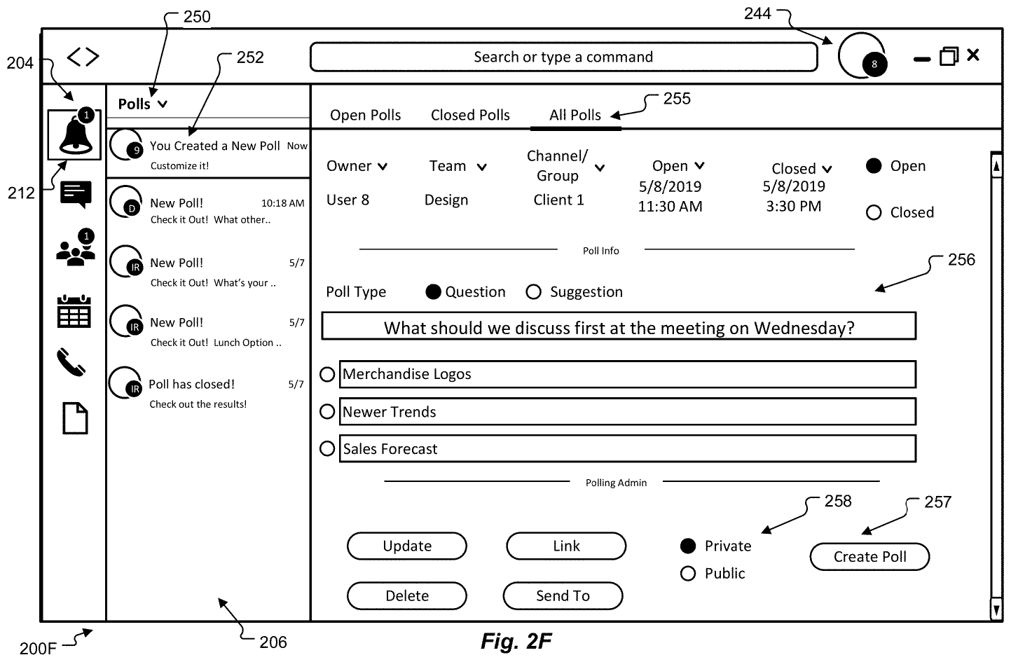

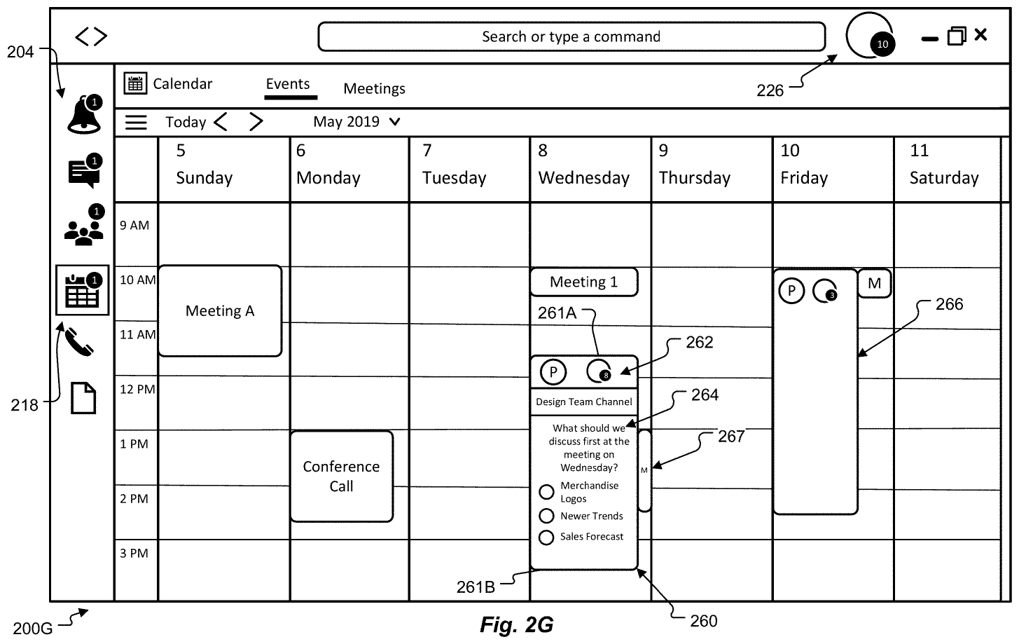

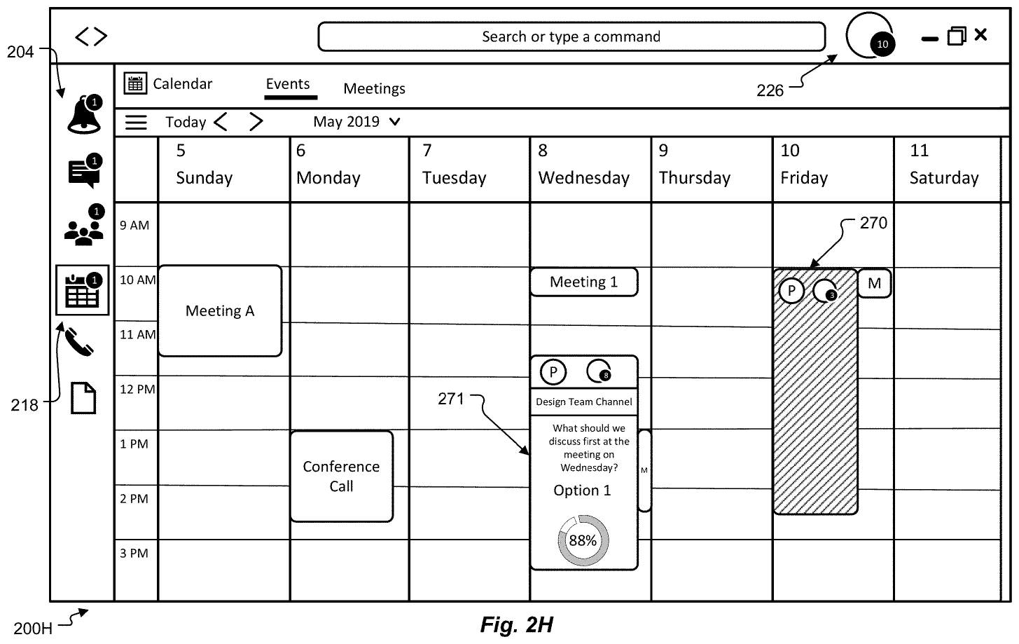

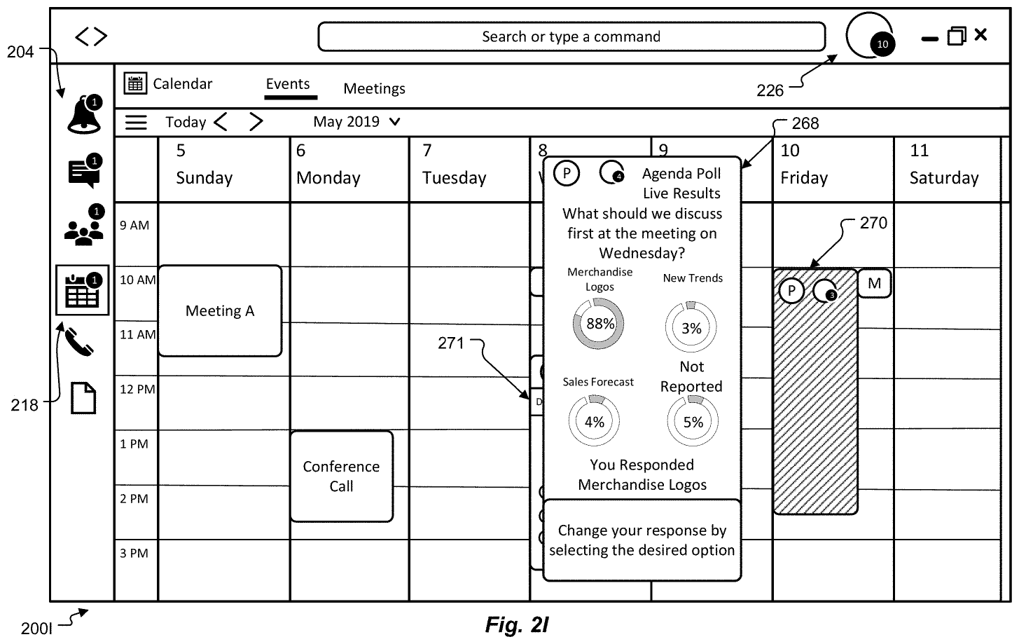

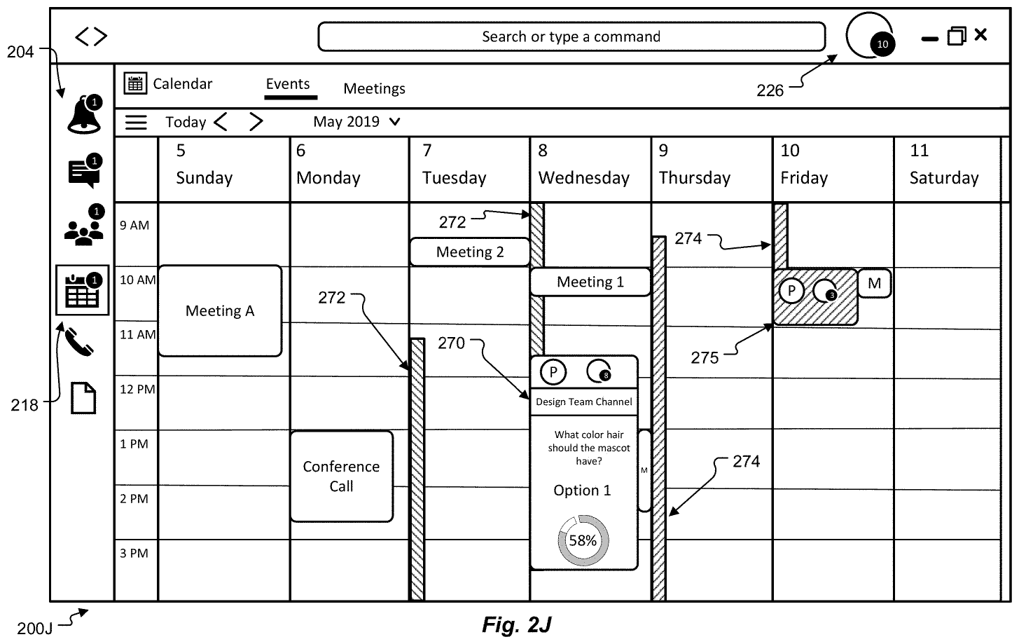

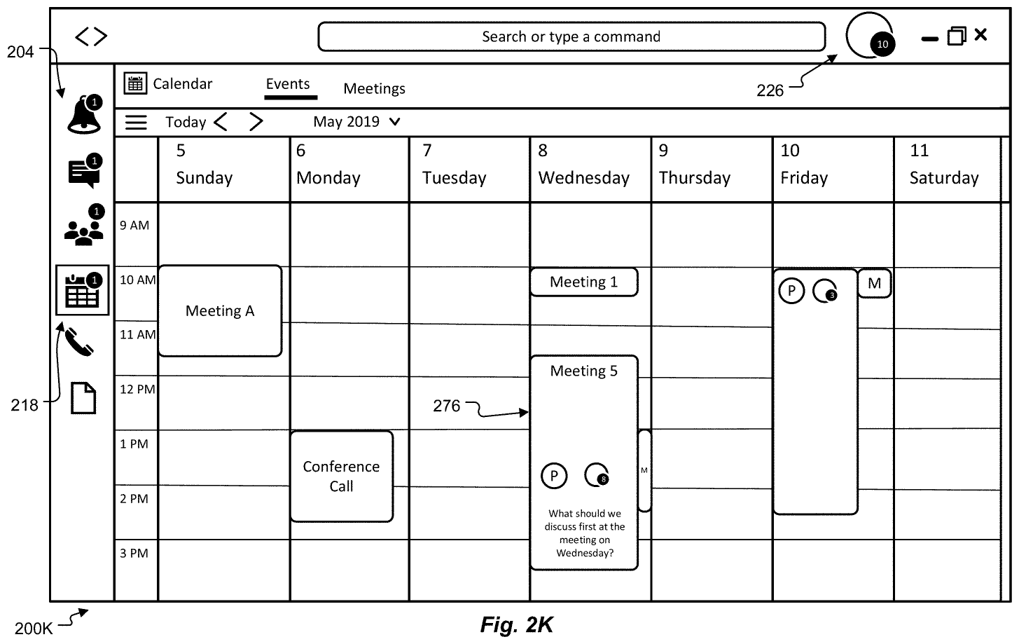

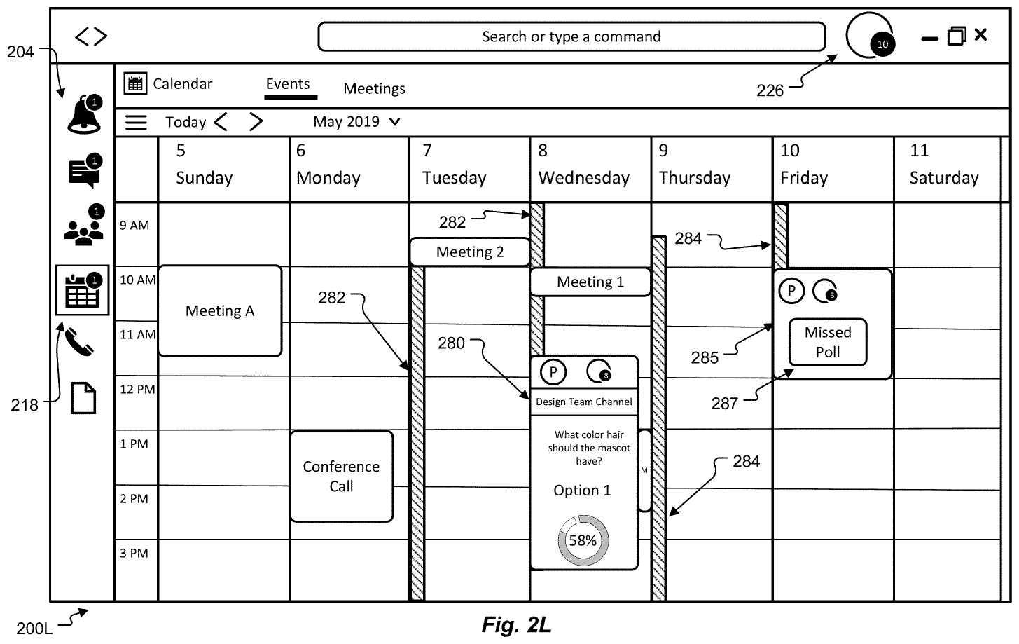

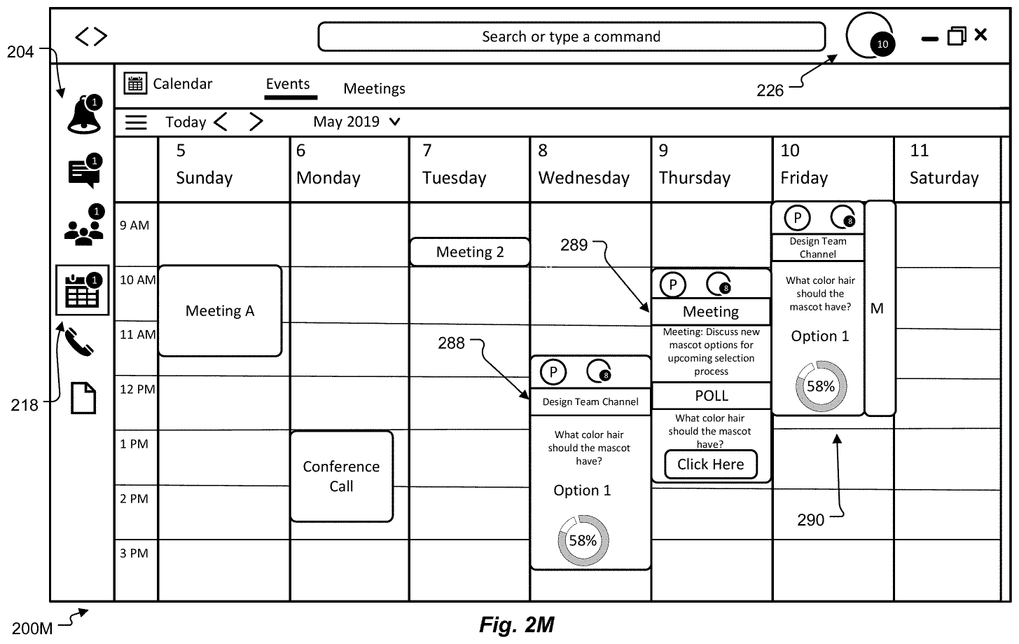

FIGS. 2A-2L provide example graphical user interfaces 200A-L that may be rendered at a user interface of one or more device 116A-C, where the conferencing, messaging, and collaboration system 104 may cause such graphical user interfaces 200A-L to be rendered. Each of the example graphical user interfaces 200A-L may be divided into to one or more areas, or portions that display information associated with a user and/or allow a user to interact with such information. For example, the graphical user interface 200A-L may include a command bar portion 204, a feed or channel portion 206, a header portion 208, and and/or a channel tab portion 210. While the example graphical user interfaces 200A-L are depicted having the command bar portion 204, the feed or channel portion 206, the header portion 208, and/or the channel tab portion 210, it should be appreciated that the graphical user interfaces 200A-L may include additional or fewer portions and/or may be arranged, configured, and/or positioned in a different manner than that which is illustrated in the graphical user interfaces 200A-L.

The command bar portion 204 may include one or more areas specific to selecting an application, app, script, or view to be provided in the feed or channel portion 206 and/or the channel tab portion 210. That is, the command bar portion 204 may include a plurality of icons which when selected, may cause a corresponding view and/or information of a corresponding view to be provided or displayed in the feed or channel portion 206 and/or the channel tab portion 210. For example, when an activity icon 212 is selected, one or more of user, team, or group activity information may be displayed in the feed or channel portion 206 and/or the channel tab portion 210. Such user, team, or group activity information may be filtered and/or displayed based on a current user logged into or otherwise utilizing the one or more graphical user interfaces 200A-L. In addition, the activity icon 212 may dynamically change to indicate a number 205 of new activities, some of which may be unseen or unviewed by the user, that may have been added, posted, or otherwise made available to a team, group, channel, thread to which the user belongs or is otherwise associated. As another example, when a messaging icon 214 is selected, one or more messages associated with the user, a group to which the user belongs, a team to which the user belongs, and/or a channel to which the user belongs, may be displayed in the feed or channel portion 206 and/or the channel tab portion 210. Such user, team, or group messaging information may be filtered and/or displayed based on a current user logged into or otherwise utilizing the one or more graphical user interfaces 200A-L. As another example, when a team icon 216 is selected, information associated with one or more teams, groups, or organizational units to which the user may belong may be displayed in the feed or channel portion 206 and/or the channel tab portion 210. Such team information may be filtered and/or displayed based on a current user logged into or otherwise utilizing the one or more graphical user interfaces 200A-L. As another example, when the calendar icon 218 is selected, information associated with a calendar application and/or a calendar view graphically depicting one or more events, meetings, or other scheduled or to-be-scheduled items may be displayed in the feed or channel portion 206, the channel tab portion 210, or in an area including both the feed or channel portion 206 and the channel tab portion 210. As another example, when the communication icon 220 is selected, one or more options for communicating with another user, such as chat, phone, video conferencing, audio conferencing, etc. may be displayed in the feed or channel portion 206 and/or the channel tab portion 210. As another example, when the files icon 222 is selected, one or more files associated with the user, group, team, channel, or thread to which the user belongs, or is otherwise associated may be displayed in the feed or channel portion 206 and/or the channel tab portion 210. Such file information may be filtered and/or displayed based on a current user logged into or otherwise utilizing the one or more graphical user interfaces 200A-L.

The feed or channel portion 206 may display one or more feeds, channels, or threads associated with the user, a group to which the user belongs, a team to which the user belongs, an organizational unit to which the user belongs, and/or a thread to with the user belongs or is otherwise associated with. For example, when an activity icon 212 is selected as depicted in the graphical user interface 200A, one or more feeds, or communications associated with the user, may be displayed in the feed or channel portion 206. Upon selection of a feed by the user, for example 224, additional information and/or details associated with the selected feed 224 may be displayed in the channel tab portion 210. The channel tab portion 210 may display, for example, a conversation, files, an organization, activity, etc. associated with user activity and/or the selected feed 224.

As another example, a history of instant messages, or chats, may be displayed in the channel tab portion 210, where the user is associated with one or more of the instant messages, or chats, in the history of the instant messages. Moreover, the channel tab portion 210 may include a scroll bar such that a user may navigate to one or more other instant messages displayed in the instant message history, or feed. The header portion 208 may include a user avatar 226 which may provide identifying information of the user currently logged into, authenticated with, or otherwise associated with the information displayed in the graphical user interface 200A. For example, User 10 may be a user logged into or otherwise utilizing the graphical user interface 200A; accordingly, messaging information, calendar information, etc. may be displayed or otherwise filtered based on User 10.

FIG. 2B depicts details of a graphical user interface 200B in accordance with examples of the present disclosure. Information in the graphical user interface 200B may be displayed upon a user selecting the messaging icon 214 of the command bar portion 204. Accordingly, the feed or channel portion 206 may display one or more conversations, threads, or instant messages associated with the user, for example User 10. That is, similar to the activity information previously described, the feed or channel portion 206 may display one or more instant message communications associated with a user. Upon selection by a user, for example if User 10 selected the chat 228, the channel tab portion 210 may display additional information about the selected chat 228. For example, the channel tab portion 210 may display or otherwise identify the users 232 that have been involved with, part of, or otherwise contributed to the selected chat 228. The channel tab portion 210 may illustrate or otherwise render one or more instant messages associated with the selected chat 228. Further, a scroll bar may be provided allowing a user, such as User 10, to view previous messages associated with the selected chat 228.

FIG. 2C depicts details of a graphical user interface 200C in accordance with examples of the present disclosure. Upon selection of the team icon 216, information associated with one or more teams or groups to which the user may belong may be displayed in the feed or channel portion 206 and/or the channel tab portion 210. For example, the feed or channel portion 206 may display a Design Team 236A which may be subdivided into one or more sub-teams, channels, groups, or threads 238. One or more of the sub-teams, channels, groups, or threads 238 may be associated with the user, User 10. As another example, an Investor Relations team 234B may be displayed along with sub-team, subgroup, channel, or thread 240. Upon selection of the sub-team, channel, group, or thread 240, the channel tab portion 210 may display additional details associated with the selected sub-team, subgroup, channel or thread. For example, one or more reports uploaded by User Fourteen may be displayed in an area 242. As can be appreciated, the reports themselves may be messages or otherwise may include communications and/or comments from one or more users.

FIG. 2D depicts details of a graphical user interface 200D in accordance with examples of the present disclosure. Upon selection of the calendar icon 218, a calendar view depicting one or more events, meetings, or items of a user's schedule may be displayed. The calendar view may depict meetings, events, conference calls, etc. and may be organized according to date, time, event type (meeting, event, calls etc.). As can be appreciated, the items depicted in the calendar view may originate from or otherwise be pulled from one or more data sources storing such scheduled items. As further depicted in FIG. 2D, the calendar icon 218 may change or otherwise be dynamically updated to reflect any new events, meetings, etc. that may have been added to a user's calendar which the user may or may not have previously viewed or seen.

In accordance with examples of the present disclosure, and as depicted in FIG. 2E, a user, such as User Eight, may wish to solicit information from one or more users. Thus, the conferencing, messaging, and collaboration system 104 may provide the ability for one or more users to create a poll, or survey, to obtain or otherwise gather information from one or more users. A poll is generally used to ask one simple question while a survey is generally used to ask a wide range of multiple questions. A poll, or survey, may be created at any point and/or at any time when a user interacts with the graphical user interface, such as the graphical user interfaces 200A-200D as previously described as well as graphical user interfaces 200E-200L. For example, during an instant messaging session, such as a selected instant message chat 246, a user, such as User Eight (244) may decide to create a poll to collect information from the users participating in the selected instant message chat 246. In some non-limiting examples, the poll or survey may collect information from users grouped by a specified team, channel, group, sub-group, chat, or thread. A user may initiate the creation of a poll, or survey, by right-clicking in the area 248 and selecting Create New Poll. As another example, a user may select a menu drop down from the graphical user interface 200E.

FIG. 2F depicts additional details related to the poll, or survey, creation process. For example, poll related information 254 may be displayed and may indicate an owner of the poll (User Eight), a team to which the poll has been assigned (e.g., the Design Team), one or more channels that the poll may be associated with or otherwise assigned to (e.g., Client 1), and an open or start time of the poll and a close or end time of the poll. Such features may be selected by the user during a poll configuration process. The user may also select a type of poll, such as a question or suggestion, where a question would solicit feedback from the user and a suggestive poll may provide one or more suggestions based on information in one or more feeds, teams, polls, channels, or groups. As further depicted in the graphical user interface 200F, the user may configure the poll such that the poll is private or public utilizing the public/private indication 258, as well as provide additional options specific to one or more administrative features of the poll. Upon creating the poll utilizing the create button 257, the poll, or survey, may assigned to the selected or otherwise designated users and may be open for accepting results, or soliciting information from the one or more designated users between the start and end times of the poll.

Although the graphical user interface 200F displays details of the poll creation process, the graphical user interface 200F may also display information according to a selected view of the user. For example, a user may have the option to display all polls 255, closed poles, and/or just open poles. Thus, the user may be able to select one or more polls to provide information and/or edit a poll which the user previously created or otherwise possess credentials to do so. Further depicted in the graphical user interface 200F, a list of activities associated with a polling creation process may also be displayed in the feed or channel portion 206.

FIG. 2G depicts details of a graphical user interface 200G in accordance with examples of the present disclosure. As depicted in FIG. 2G, the creation of the poll may cause a depiction of the created poll to appear in a calendar view associated with the user. For example, a graphical element 260 associated with a timeslot in the calendar application or calendar view may be displayed. The graphical element 260 may indicate to a user, such as User Ten, that a poll has been created, where an open or starting time for the poll may be associated with a time slot in the calendar application or calendar view and the closing or ending time for the poll may be associated with a different time slot in the calendar application or calendar view as indicated by the upper portion 261A of the graphical element 260 and the lower portion 261B of the graphical element 260. Moreover, the graphical element 260 may include additional information, such as a user or user account that created the poll associated with the graphical element 260 and that the graphical element 260 depicted in the calendar view or calendar application is indeed a poll (as depicted by the P in the circle). The graphical element 260 may further display information associated with the poll, for example the poll question 264 and one or more responses that may be selectable by the user. That is, the graphical element 260 may solicit a response from a user, such as User Ten. In some instances, the graphical element 260 may be displayed next to another event, such as meeting 267, where the poll associated with the graphical element 260 and the meeting 267 may or may not be related or otherwise associated with one another.

As further depicted in FIG. 2G, a graphical element 266 associated with a second poll may be displayed; however, unlike the graphical element 260 associated with the first poll, the graphical element 266 associated with the second poll may indicate that the second poll is not yet open, active, or otherwise ready to solicit or receive information from a user. That is, the graphical element 266 may provide basic poll information, such as a user or user account that created the poll (User Three) and an indication that the graphical element 266 is associated with a poll. However the absence of additional information for the graphical element 266 may indicate that the poll associated with the graphical element 266 is not yet open. For example, the graphical element 266 does not display or otherwise indicate a poll question or possible options selectable by a user. Alternatively, or in addition, the absence of information associated with the graphical element 266 may indicate that the current user, such as User Ten, does not possess or otherwise has not been assigned a sufficient level of permissions or privileges to view additional information associated with the poll represented by the graphical element 266.

In accordance with some examples, a graphical element may indicate that the poll associated with the graphical element is closed. For example, as depicted in in the graphical user interface 200H of FIG. 2H, the graphical element 270 may include an indication, such as but not limited to a shading, a different color, a shape, an image, etc., that provides information that a poll associated with the graphical element 270 is not yet open. As further depicted in the graphical user interface 200H, a size of the graphical element associated with a poll, for example the graphical element 270, may be indicative of a duration in which the poll may be open or otherwise available to solicit information from a user. Further, the uppermost portion of the graphical element, such as graphical element 270, may indicate a start time, for instance 10:00 AM while the bottommost portion of the graphical element, such as the graphical element 270, may indicate an end time, such as 2:30 PM.

In accordance with some examples, the graphical element, such as graphical element 271, may provide additional information about the poll. As depicted in FIG. 2H, live results may be shown in the graphical element 271 of the calendar view. The graphical element 271 may also indicate additional poll information, such as a team, channel, or thread associated with the poll. Further, a user, such as User Ten, may be able to click on graphical element to obtain additional information about the poll. For example, upon a click on the graphical element 271, live poll results may be displayed in the graphical element 268 depicted in the graphical user interface 200I of FIG. 2I. The graphical element 268 may be interactive in that a user may be able to change a previously submitted response.

FIG. 2J depicts details of a graphical user interface 200J in accordance with examples of the present disclosure. In some examples, a start time associated with a poll may span, or otherwise be open for receiving results from a user or soliciting information from a user, over several days; accordingly, in a calendar view or calendar application as depicted in the graphical user interface 200J, a second graphical element, such as the graphical element 272, may span multiple days and may end, or start, at a graphical element as depicted by the graphical element 270. As further depicted in the graphical user interface 200J, a time associated with an open and close time may be depicted at the calendar view or the calendar application. For example, a poll associated with the graphical element 275 may not yet be open or otherwise not accepting results from one or more users. Accordingly, the graphical element 274—which may be different from the graphical element 272 (as illustrated by the direction of cross-hatching), may be displayed, where the graphical element 274 would generally indicate that a poll associated with the graphical element 275 would open at 9:30 AM on Thursday; the graphical element 275 would indicate that such associated poll would close at 11:00 AM on Friday.

In accordance with examples of the present disclosure, a graphical element associated with a poll may be combined with or otherwise integrated into an existing or new event, such as a meeting. For example, FIG. 2K depicts details of a graphical user interface 200K in accordance with examples of the present disclosure. The graphical user interface 200K depicts an instance where a graphical element 276 indicates that a meeting, such as Meeting 5 includes a poll. Alternatively, or in addition, during a meeting, for example, during the Meeting 5, a poll is created and issued to one or more attendees of the meeting, such as at an all-hands meeting for example. Accordingly, a poll may be combined with an existing meeting event. In some instances, the open and close times associated with a poll may be derived from existing meeting events. As another example, during a meeting creation and/or scheduling process, a user may have the ability to create a poll and have such poll be available to users as they accept an invite, for example, to the meeting. Accordingly, when the event is added to user's calendar, the graphical element for the event may indicate that the event has a poll that has been associated with the event.

In some instances, a poll may be inserted into a user's calendar view and/or calendar application because the user missed the poll when the poll was created or otherwise activated. That is, the graphical element 280 and graphical element 285 may correspond to polls which the user has missed as depicted in the graphical user interface 200L of FIG. 2L. For example, if a poll had been assigned to a group, thread, channel, sub-channel, etc. of which the user is a member, and the user has not provided a poll response, the poll may be inserted into the calendar application and/or calendar view of the user. As one example, the user may have missed Meeting 2 on Tuesday in which a poll was dynamically created; accordingly, the graphical elements 282 and 280 may be inserted into the user's calendar view and/or calendar application such that the user may respond to the poll, where the graphical element 282 indicates that the poll is open from Meeting 2 and the graphical element 280 indicates that the pole will close at 3:30 PM on Wednesday. As another example, during a dynamic event such as a chat session or phone call, a poll may have been created at 9:30 AM on Thursday; accordingly, the graphical element 284 and 285 may be inserted into the user's calendar view and/or calendar application. In some instances, an identifier, such as “Missed Poll” may be placed on a graphical element, such as graphical element 285, indicating that the user has missed the poll. In some instances, the identifier may include an indication of importance.

FIG. 2M depicts details of a graphical user interface 200M in accordance with examples of the present disclosure. In some examples, the graphical element may be a graphical element associated with a meeting element, such as the graphical element 290, may be a graphical element that includes both a meeting component and a poll component, such as graphical element 289, or may be a graphical element that only includes information related to the polling component, such as the graphical element 289. Each of the graphical elements 288, 289, and/or 290 may respond in the same, similar, or different manner when interacted with by a user. For example, the graphical element 289 may respond by providing additional poll information, similar to that which is shown in the graphical user interface 200I. Further, meeting details may be displayed in addition to the additional poll information. Similarly, the graphical element 290 may only display poll related information if clicked, while a meeting graphical element adjacent to the graphical element 290 may only display meeting related details when interacted with or clicked. Of course, other variations to the graphical elements and how information is possibly shared between meeting graphical elements and/or poll graphical elements are possible and contemplated.

In accordance with examples of the present disclosure, each of the previously described graphical elements may be considered to be an object having different properties and dependent upon differing roles. Objects may consume different resources and/or be a provider of information or act as another resource. Such information consumed or provided may depend on the role of the graphical element and a context in which the graphical element is provided. For example, a graphical element or object may provide live polling information or not provide live polling information depending on whether the graphical element is assigned to a role, a user of the graphical element is assigned to a role, and/or an organizational unit associated with the graphical element is assigned to a role.

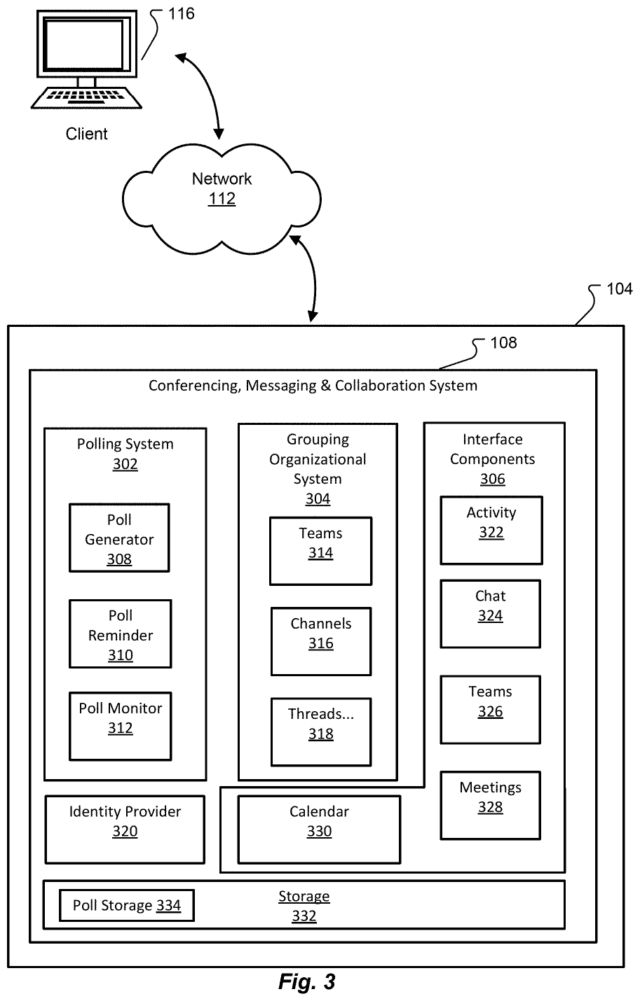

FIG. 3 depicts additional details of the Conferencing, Messaging & Collaboration System 108 in accordance with examples of the present disclosure. More specifically, FIG. 3 depicts a Conferencing, Messaging & Collaboration system 104 which may reside at one or more data processing devices, such as one or more servers or the like, and may include the conferencing, messaging & collaboration System 108 as previously described. The conferencing, messaging & collaboration System 108 may include a polling system 302, a grouping organizational system 304, interface components 306, an identity provider 320, and storage 332. The grouping organizational system 304 generally provides a way to hierarchically organize users, projects, tasks, communications, and user interactions in such a manner so as to foster collaboration and organization in team environments. In accordance with examples of the present disclosure, the grouping organizational system 304 may allow one or more users to be organizationally assigned or otherwise grouped according to one or more teams 314. Further, a user may be grouped or otherwise assigned to one or channels 316, where each channel 316 may include one or more threads 318. Of course, each thread 318 may be further divided if need be as indicated by the ellipses. The interface components 306 generally correspond to the one or more icons in the command bar portion 204 of the graphical user interfaces 200A-L. The interface components 306 generally provide one or more options for allowing a user to interact with the Conferencing, Messaging, & Collaboration system 108. Accordingly, a user may see latest activity utilizing the activity component 322, chat and communicate with instant messages using the chat component 324, change assignments, view documents, subdivide tasks, and manage groupings utilizing the teams component 326, hold meetings utilizing the meetings component 328, and view, track, schedule, and change events, meetings, or other scheduled items utilizing the calendar component 330. The identity provider 320 is generally responsible for determining a user's identity through an authentication process and enforcing one or more access controls for allowing and/or restricting access to one or more groups and/or interface components. The one or more access controls for allowing and/or restricting access to one or more groups and/or one or more interface components may also depend on a role assigned to a user. For example, a role may determine what permissions and/or what access a user has within or for another object. In some examples, the role may before an organizational unit and/or for a component of the organizational unit. For example, a user assigned to a team may be assigned to a team role providing the user access to one or more areas of the team but may restrict the user from adding content and/or creating polls. In some examples, a user may be assigned multiple rolls. The role may dictate which users have access to which resources and how such resources may be utilized; a role may dictate which resources have access to which users how the resource can interact with the users. As one example, inserting polling information into a calendar view may depend on whether a resource has sufficient privileges and/or access rights to a calendar object and/or to modifying a calendar object. In some examples, inserting polling information into a calendar view may depend on whether a user has sufficient privileges and/or access rights for the polling information to be inserted into a calendar object and/or how polling information is inserted into the calendar object.

The polling system 302 includes one or more components responsible for implementing polls and/or surveys in accordance with examples of the present disclosure. More specifically, the polling system 302 may include a poll generator 308, a poll reminder 310, and a poll monitor 312. The poll generator 308 provides the ability for a user to create, management, and assign one or more polls to one or more events, persons, users, and/or objects. For example, the poll generator 308 may generate poll information that is no just accessible to a user, but may be accessible to one or more other components of the conferencing, messaging, & collaboration system 104 such as the calendar component 330. In some examples, the identity provider 320 may be relied upon by the polling system 302 to ensure that the correct users have the necessary permissions to interact with a poll or survey. Thus, a user may create a poll and assign the poll to one or more users. The polling system 302 may then communicate with calendar component 330 to provide one or more portions of the poll information such that a graphical element may be displayed in a user's calendar application and/or calendar view. In some instances, the polling system 302 may provide a start and end time for a poll such that a graphical element may be generated and displayed at a user's calendar application and/or calendar view. In some instances, the polling system 302 may store poll information in a poll storage 334 of the storage 332 and provide the calendar component 330 a reference, or link, to the information stored in the poll storage 334. Accordingly, the calendar component 330 may reference the link to retrieve calendaring information, such as a start time and end time of the meeting. In some examples, the poll storage 334 may include additional information about the poll, such as results of the poll, live results of the poll, and a link to the poll such that a user can complete or participate in the poll. Although depicted as residing within messaging, conferencing, and collaboration system 108, it should be appreciated that one or components and/or elements described above may reside outside of but be communicatively coupled to the messaging, conferencing, and collaboration system 108.

The poll monitor 312 may monitor which users have responded to a particular poll. For example, if a group to which a first user belongs was assigned a poll, and/or if the user was directly assigned a poll, the poll monitor 312 may determine whether the user responded to the poll. Thus, the poll monitor may track which users have responded and which users have not responded. The poll reminder 310 may provide a notification to the calendar component 330 indicating that a particular user has not responded to a poll. Accordingly, the poll reminder 310 may act as a notification module notifying the calendar application that a graphical element should be inserted into the user's calendar view and/or calendar application.

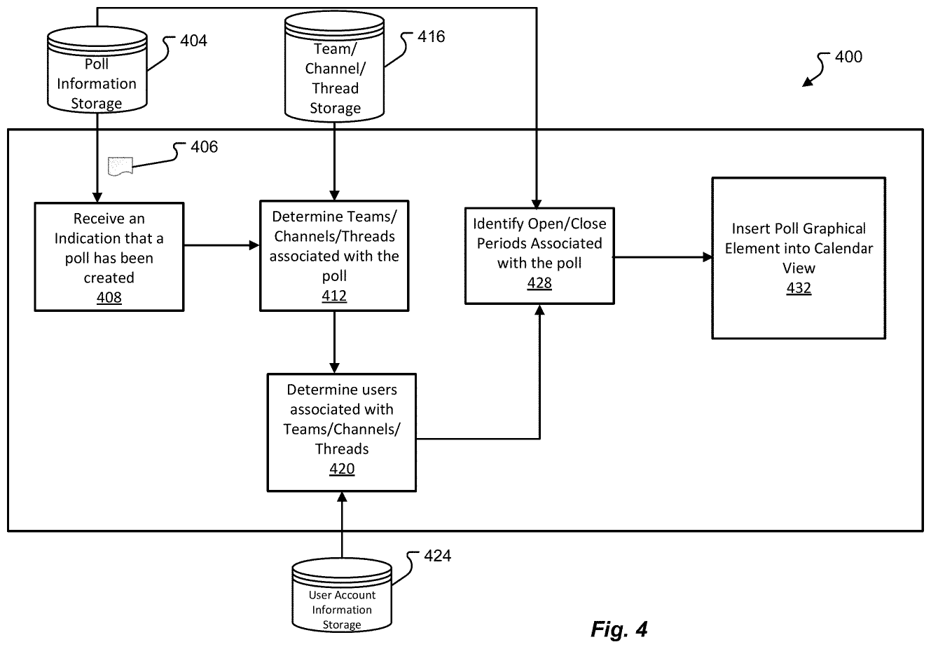

FIG. 4 depicts additional details directed to inserting poll information into a user's calendar view and/or calendar application utilizing a conferencing, messaging, and collaboration system 400. The conferencing, messaging, and collaboration system 400 may be the same as or similar to the conferencing, messaging, and collaboration system 108 previously described. In some instances, the poll information may be stored in the poll information storage 404; the poll information storage 404 may be the same as or similar to the poll storage 334. A notification 406 may be provided from the poll information storage 404 or a service associated with a new poll creation and/or notification to provide a notification to a calendar component, such as the calendar component 330. At 404, the notification 406 that a poll has been created may be received and based on the indication, poll assignments can be determined. For example, the poll information may indicate which users, teams, channels, and/or threads are associated with the poll at 412; in some instances, the poll information may include unique identifiers identifying users, teams, channels, and/or threads associated with the poll; accordingly, the identity provider 320 and/or the calendar component 330 may request information from the team/channel/thread storage 416 and/or use9r information 424 to determine teams, channels, and threads associated with the poll at 412 and to determine users associated with the teams, channels, and threads information and/or users account information from the user account information storage 424 may be obtained to determine one or more users associated with the teams, channels, and threads at 420. In some instances, the calendar component 330 may identify open and closed periods associated with the poll at 428 and proceed to insert the a poll graphical element into a calendar view 432 of a specific user, where the graphical element may be dependent on the poll information. Accordingly, when a user selects a calendar view or calendar application, for example by selecting the calendar icon 218, a calendar view, for example the calendar view of the graphical user interface 200G, may be displayed.

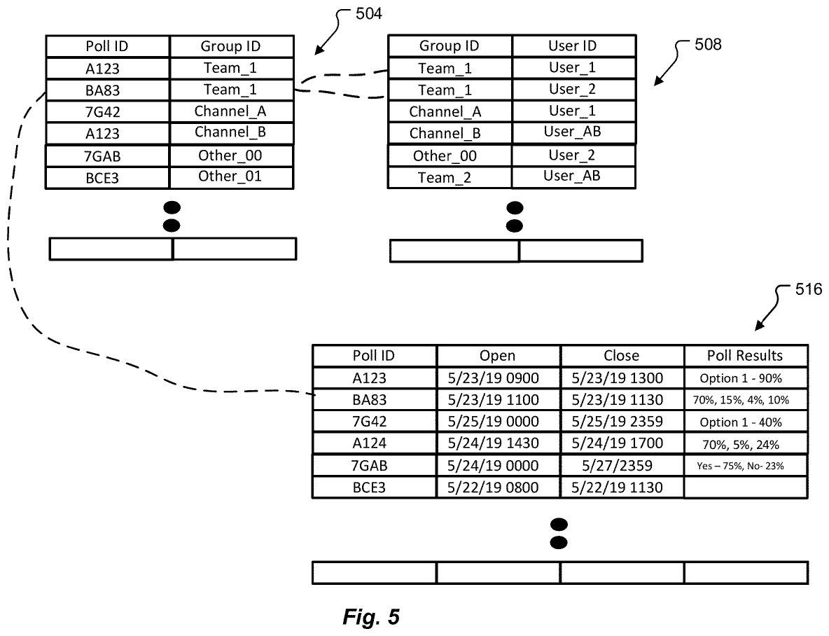

FIG. 5 depicts one or more data structures illustrating user and group poll assignments in accordance with examples of the present disclosure. A first data structure 504 may include a poll identifier and a group identifier, where the group identifier may uniquely identify one or more groups, threads, channels, or organizational units to which a user is associated with or otherwise belongs. In instances when a poll may be assigned to a plurality of users, such as by being assigned to a group (team, channel, thread, etc.), the group identifier may be used to identifier one or users in the group using a second data structure 508. For example, a group identifier of Team_1 may correspond to User_1 and User_2, where User_1 and User_2 may have been assigned to a same team (Team_1). Further, the data structure 516 may store poll information. For example, open time, close time, and poll result information may be associated with a poll identifier. Accordingly, by having a poll identifier, the calendar component 330 of the messaging, conferencing, and collaboration system 104 may generate graphical elements corresponding to each poll and include such graphical elements in a calendar view for a user based on poll and group assignments.

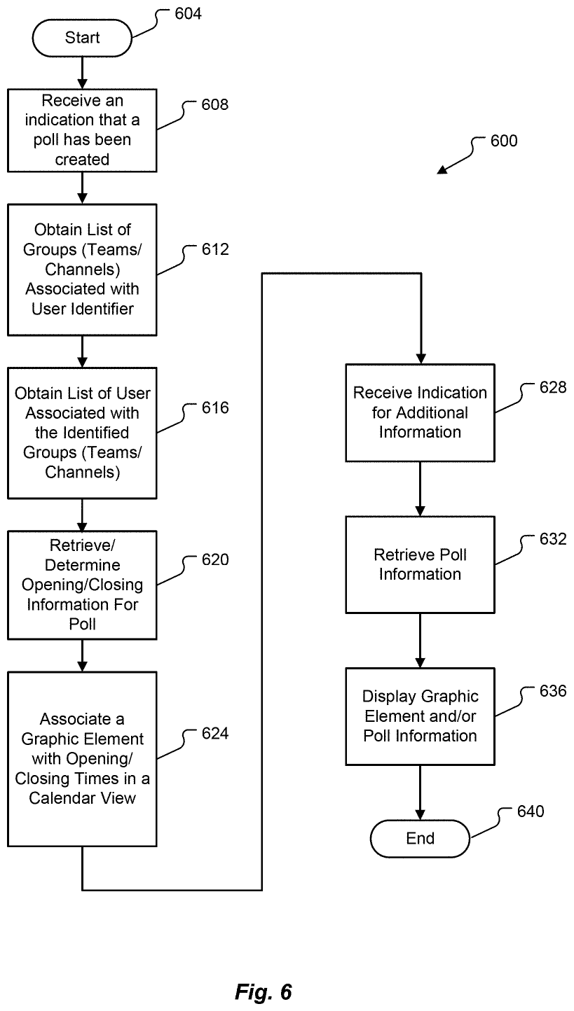

FIG. 6 depict details of a method 600 for generating a graphical element for display in a calendar view and/or calendar application associated with a user. A general order for the steps of the method 600 is shown in FIG. 6. Generally, the method 600 starts with a start operation 604 and ends with the end operation 640. The method 600 may include more or fewer steps or may arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIGS. 1-5.

The method 600 starts at 604 and proceeds to 608, where an indication may be received indicating that a poll has been created. For example, a calendar application may receive a notification 406 indicating that a new poll has been created and/or that a poll has been assigned to a specific user or group of users. The method may proceed to 612, where a list of groups to which the poll has been assigned may be retrieved. The method may then proceed to step 616, where a list of users associated with the one or more groups to which the poll has been assigned, may be retrieved. At 620, poll information such as, opening and closing information may be retrieved. Based on the retrieved poll information, one or more graphic elements may be associated with a time slot corresponding to the opening and closing times of the poll. For example, if a poll were to span a few hours, a graphic element such as 260 may be presented. Should the poll span a few days, graphic elements similar to 272, 274, and/or 270 may be displayed. In some instances, the graphic element may be dependent upon whether the poll is open or closed etc.

At step 628, an indication, such as a selection of a graphic element associated with a poll may be received. For example, a user may click on a graphic element 271 and wish to view live poll results. At 632, additional information associated with the poll, such as live poll results, may be retrieved. For example, the live poll results may be retrieved from poll storage 334, assembled, and associated with one or more graphics. That is, a graphical element capable of displaying the additional poll information may be determined and associated with the graphical element. For example, a graphical element 268 may be determined and/or associated with a request for additional poll information. In some instances, the graphical element may reside in poll storage 334. At 636, the graphical element, such as the graphical element 268—including the additional poll information may be displayed in a calendar view and/or a calendar application. The method 600 may end at 640.

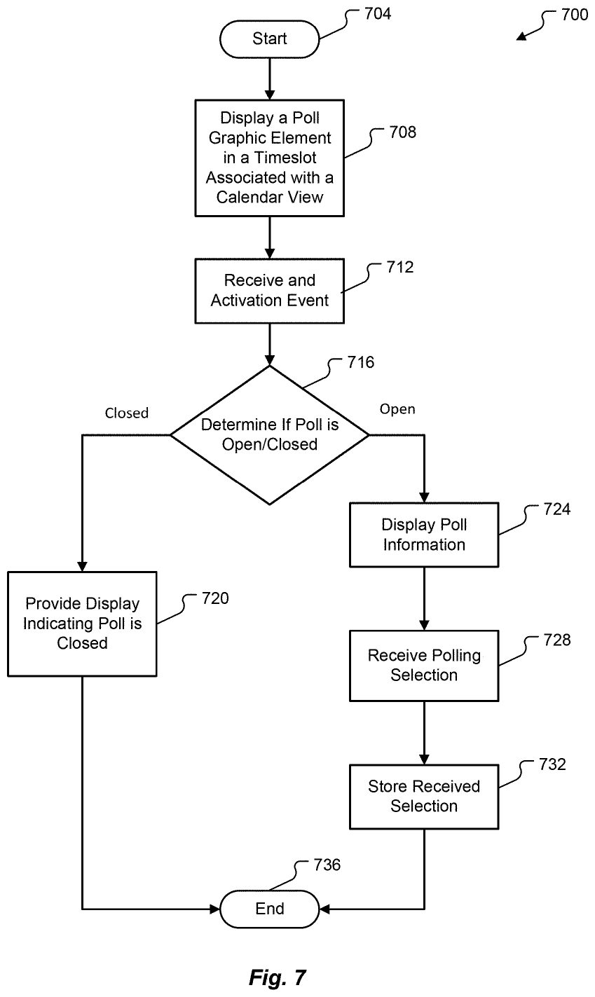

FIG. 7 depict details of a method 700 for providing a graphical element based on a selection of a graphical element in a timeslot of a calendar view and/or calendar application. A general order for the steps of the method 700 is shown in FIG. 7. Generally, the method 700 starts with a start operation 704 and ends with the end operation 736. The method 700 may include more or fewer steps or may arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, Application Specific Integrated Circuit (ASIC), a field programmable gate array (FPGA), a system on chip (SOC), or other hardware device. Hereinafter, the method 700 shall be explained with reference to the systems, components, modules, software, data structures, user interfaces, etc. described in conjunction with FIGS. 1-6.

The method 700 starts at 704 and proceeds to 708, where a graphical element associated with a poll, such as a graphical element 271, may be displayed in a timeslot of a calendar view and/or calendar application. At 712, an activation event may be received. For example, the activation event may correspond to a user clicking on the graphical element or a portion of a graphical element, such as a graphical element 271. A user may click on the graphical element in order to cast a vote in a poll or provide additional information in a survey. If the activation event corresponds to an event indicative of a user wishing to provide additional information for a poll or survey, the method may proceed to 716 where the method may determine whether the poll is open or closed. For example, the method may obtain a current time and compare the current time to a poll open time and/or a poll closed time. If the current time is before the poll open time or if the current time is after the poll close time, the method 700 may proceed to 720, where a message indicating that the poll is closed may be displayed to a user. Alternatively, or in addition, a graphical element, such as the graphical element 274, may indicate that the poll is closed and may be displayed to a user. If the current time is between the poll open time and the poll close time, the method may proceed to 724, where poll information may be displayed. For example, a question in the poll, potential answers in the poll, results of the poll, and the like may be displayed to a user. At 728, the method 700 may receive a poll selection, for example a top choice. The poll selection may then be stored, for example, in the poll storage 334. The method 700 may then end at 736.

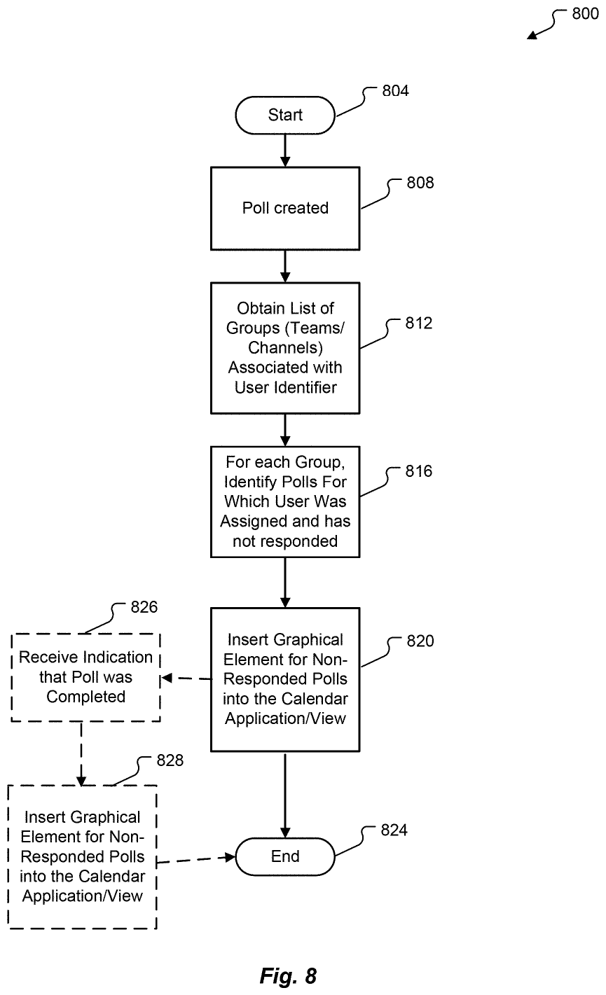

FIG. 8 depict details of a method 800 for determining which polls to cause to be displayed at a calendar view and/or calendar application. A general order for the steps of the method 800 is shown in FIG. 8. Generally, the method 800 starts with a start operation 804 and ends with the end operation 824. The method 800 may include more or fewer steps or may arrange the order of the steps differently than those shown in FIG. 8. The method 800 can be executed as a set of computer-executable instructions executed by a computer system and encoded or stored on a computer readable medium. Further, the method 800 can be performed by gates or circuits associated with a processor, Application Specific Integrated Circuit (ASIC), a field programmable gate array (FPGA), a system on chip (SOC), or other hardware device. Hereinafter, the method 800 shall be explained with reference to the systems, components, modules, software, data structures, user interfaces, etc. described in conjunction with FIGS. 1-7.

The method 800 starts at 804 and proceeds to 808, where an indication that a poll has been created is received. For example, a calendar application may receive a notification 406 indicating that a new poll has been created and/or that a poll has been assigned to a specific user or group of users. The method may proceed to 812, where a list of groups to which the poll has been assigned may be retrieved. The method may then proceed to step 816, where users that have not responded to the poll may be identified. For example, each poll may track which users have responded and which users have not responded. Accordingly, for the users that have not responded to the poll, a graphical element indicating that a user needs to respond to a poll may be inserted into a calendar view and/or calendar application for the non-responsive user at 820. For example, a graphical element 280 or 285 may be inserted into a user's graphical user interface 200L for example. The method 800 may then end at 824. In some instances, where an indication that the poll has been completed by the user is received, for example at 826, the graphical element for the non-responded polls may be removed from the calendar view of the user at 828.

While different aspects of a graphical element, such as a graphical element 260, 266, 268, 270, 276, 280, 288, 289, and/or have been described, it should be understood that the existence of the graphical element may take one or more forms. For example, a graphical element may be displayed as a separate graphical element or as a graphical element that exists in or is otherwise part of the parent graphical element. For example, the graphical element may appear in a same stack as the parent graphical element and/or the same stack as another graphical element; accordingly, the graphical element may be in a stack position that is in front of or behind another graphical element, such as a parent graphical element. As another example, the graphical element may pop out as another separate graphical element. In accordance with some examples, the graphical element may transition from a graphical element in a same stack as a parent graphical element to a separate graphical element and/or from a separate graphical element to a graphical element in a same stack as a parent graphical element.

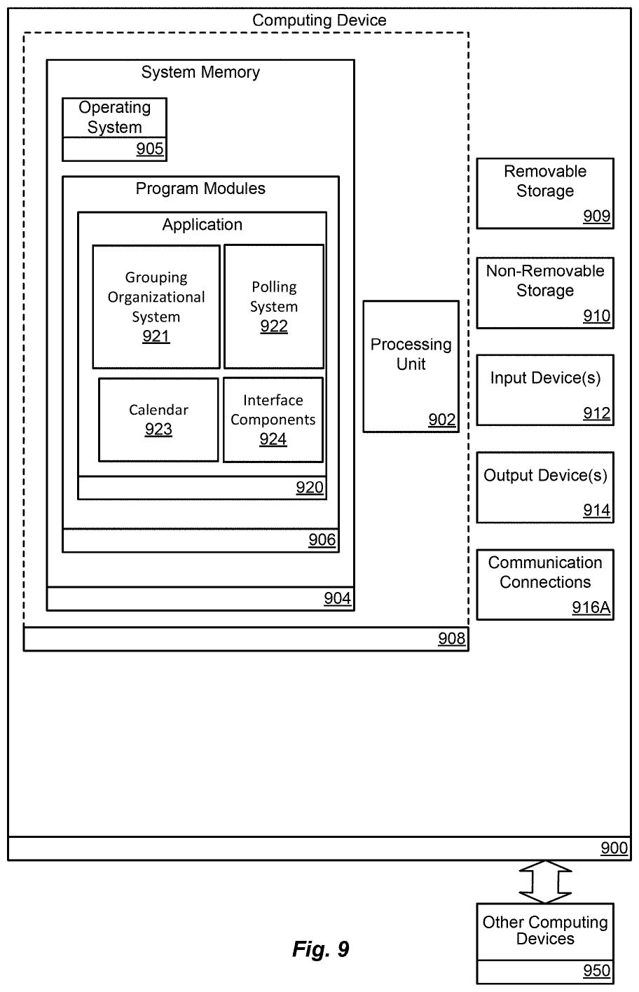

FIG. 9 is a block diagram illustrating physical components (e.g., hardware) of a computing device 900 with which aspects of the disclosure may be practiced. The computing device components described below may be suitable for the computing devices, such as the client device 116, and/or the conferencing, messaging, and collaboration system 108, as described above. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for performing the various aspects disclosed herein such as the polling system 922, interface components 924, calendar 923, and/or the grouping organizational system 921. The operating system 905, for example, may be suitable for controlling the operation of the computing device 900. Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the at least one processing unit 902, the program modules 906 (e.g., one or more applications 920) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916A allowing communications with other computing devices 950. Examples of suitable communication connections 916A include, but are not limited to, radio frequency (RF) transmitter, receiver, and/or transceiver circuitry; universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

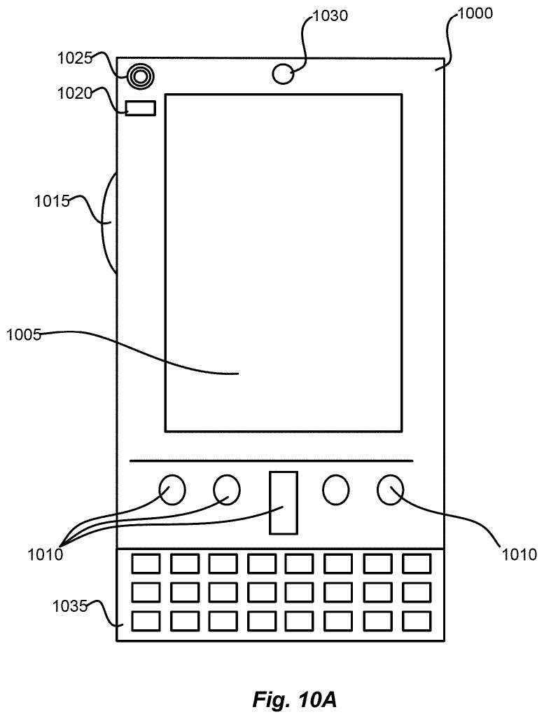

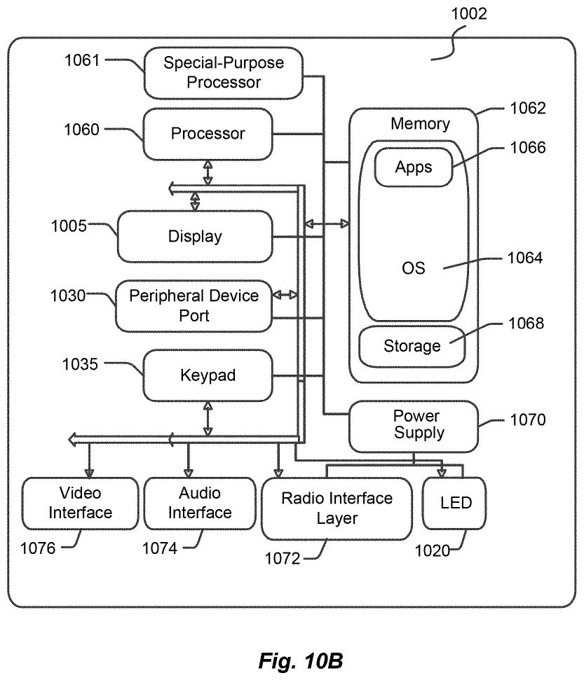

FIGS. 10A and 10B illustrate a computing device, client device, or mobile computing device 1000, for example, a mobile telephone, a smart phone, wearable computer (such as a smart watch), a tablet computer, a laptop computer, and the like, with which aspects of the disclosure may be practiced. In some aspects, the client device (e.g., 116A-116C) may be a mobile computing device. With reference to FIG. 10A, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display). If included, an optional side input element 1015 allows further user input. The side input element 1015 may be a rotary switch, a button, or any other type of manual input element. In alternative aspects, mobile computing device 1000 may incorporate more or less input elements. For example, the display 1005 may not be a touch screen in some aspects. In yet another alternative aspect, the mobile computing device 1000 is a portable phone system, such as a cellular phone. The mobile computing device 1000 may also include an optional keypad 1035. Optional keypad 1035 may be a physical keypad or a “soft” keypad generated on the touch screen display. In various aspects, the output elements include the display 1005 for showing a graphical user interface (GUI), a visual indicator 1020 (e.g., alight emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external source.

FIG. 10B is a block diagram illustrating the architecture of one aspect of computing device, a server, or a mobile computing device. That is, the computing device 1000 can incorporate a system (e.g., an architecture) 1002 to implement some aspects. The system 1002 can implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, title content, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., search engine, extractor module, relevancy ranking module, answer scoring module, etc.).

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated configuration, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with aspects of the present disclosure, the microphone may also serve as an audio sensor to facilitate control of notifications, as will be described below. The system 1002 may further include a video interface 1076 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

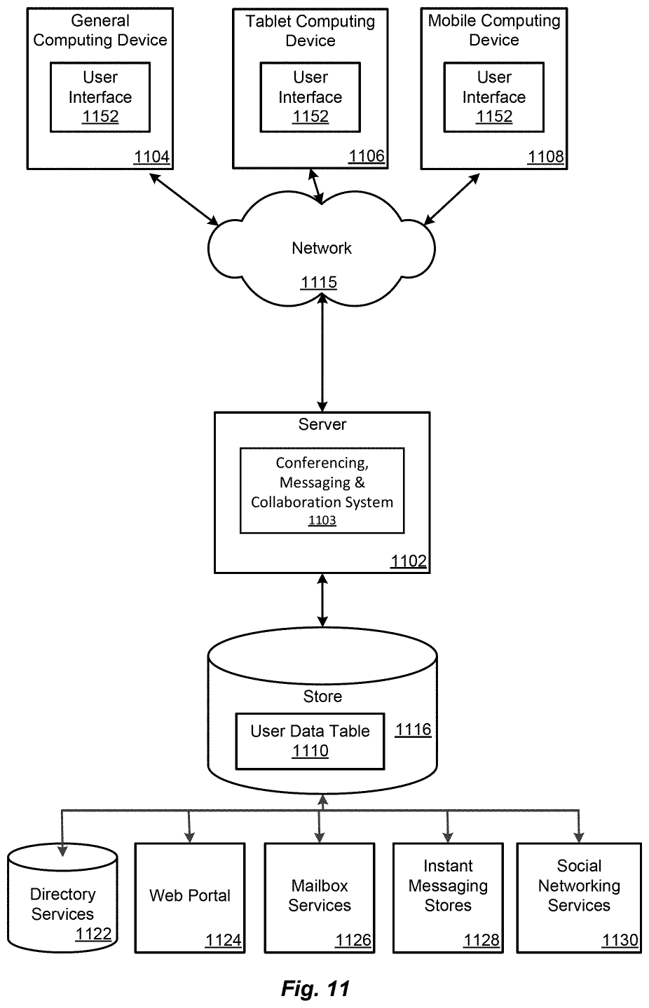

FIG. 11 illustrates one aspect of the architecture of a system for processing data received at a conferencing, messaging, and collaboration system 1103 from a remote source, as described above. Content at a server device 1102 may be stored in different communication channels or other storage types. For example, various images, or files may be stored using a directory service 1122, a web portal 1124, a mailbox service 1126, an instant messaging store 1128, or a social networking site 1130. A unified profile API based on the user data table 1110 may be employed by a client that communicates with server device 1102. The server device 1102 may provide data to and from a client computing device such as the client devices 116A-116C through a network 1115. By way of example, the client device 1106 described above may be embodied in a personal computer 1104, a tablet computing device 1106, and/or a mobile computing device 1108 (e.g., a smart phone).

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In accordance with at least one example of the present disclosure, a system for displaying a graphical element associated with a poll in a calendar view is provided. The system may include a processor and memory including instructions which when executed by the processor, causes the processor to: determine that a response from a user has not been provided to a poll event, receive poll information associated with the poll event, the poll information identifying a period of time corresponding to when the poll event is open for receiving responses from the user, determine a time slot in the calendar view of the user based on the period of time corresponding to when the poll event is open, and cause a graphical element for the poll event to be displayed in the calendar view of the user at the determined time slot.

At least one aspect of the above example includes where the instructions further cause the processor to determine that the time slot associated with the poll event corresponds to a time slot for an existing event, alter a graphical element associated with the existing event based on the poll information. At least one aspect of the above example includes where the instructions further cause the processor to receive an indication that the graphical element for the poll event has been selected, cause a second graphical element to be displayed that solicits a response from the user, and receive the response. At least one aspect of the above example includes where the instructions further cause the processor to remove the graphical element for the poll event from the calendar view or cause poll results information for the poll event to be displayed, the poll results information including the response. At least one aspect of the above example includes where the instructions further cause the processor to identify an organizational unit based on an existence of an assignment between the poll event and the organizational unit, and determine one or more users belonging to the organizational unit, the one or more users including the user that has not provided the response to the poll event. At least one aspect of the above example includes where a plurality of poll events are assigned to the organizational unit, a plurality of users are assigned to the organizational unit, and a plurality of organizational units are assigned to the poll event. At least one aspect of the above example includes where the instructions further cause the processor to cause a first graphical element for the poll event to be displayed when the polling event is open, and cause a second different graphical element for the poll event to be displayed when the polling event is closed.

In accordance with at least one example of the present disclosure, a method for displaying poll information in a calendar view depicting a plurality of events and a time slot associated with each of the plurality of events is provided. The method may include receiving poll information associated with a poll event, the poll information identifying a period of time corresponding to when the poll event is open for receiving responses and further indicating that a response to the poll event has not been received, determining a time slot in the calendar view based on the plurality of events and the period of time corresponding to when the poll event is open, and causing a graphical element for the poll event to be displayed in the calendar view at the determined time slot, the graphical element identifying a period of time corresponding to when the poll event is open for receiving responses from one or more users.

At least one aspect of the above example includes causing a first graphical element for the poll event to be displayed when the polling event is open, and causing a second graphical element for the poll event to be displayed when the polling event is closed. At least one aspect of the above example includes identifying an organizational unit to which a plurality of users belong based on an existence of an assignment between the poll event and the organizational unit, and identifying a user belonging to the organizational unit, wherein the identified user includes a user that has not provided a response to the poll event. At least one aspect of the above example includes removing the graphical element for the poll event from the calendar view. At least one aspect of the above example includes determining that the time slot associated with the poll event corresponds to a time slot associated with an existing event, and altering a graphical element associated with the existing event based on the poll information. At least one aspect of the above example includes where the altered graphical element associated with the existing event indicates the existing event includes the poll event. At least one aspect of the above example includes receiving a selection of the graphical element, causing a graphical element that solicits a response from a user to be displayed, receiving the response, and displaying polling results information for the polling event, the polling results information including the response. At least one aspect of the above example includes determining that the time slot based on the poll event corresponds to a time slot for an existing event, and causing the graphical element and a graphical element for an existing event to be displayed simultaneously at the time slot in the calendar view.

In accordance with at least one example of the present disclosure, a computer-readable storage medium including instructions is provided. The instructions, when executed by a processor, may cause the processor to receive an indication that a poll event has been created, receive a plurality of responses for the poll event, based on the plurality of received responses for the poll event, determine one or more users that have not provided a response, and cause a graphical element for the poll event to be displayed in a calendar view of the one or more users that have not provided a response.

At least one aspect of the above example includes where the instructions cause the processor to determine a time slot based on one or more properties of the poll event. At least one aspect of the above example includes where the one or more properties include a poll close time. At least one aspect of the above example includes where the instructions cause the processor to receive an indication that the graphical element for the poll event has been selected, cause a graphical element to be displayed that solicits a response from the one or more users, and receive the response. At least one aspect of the above example includes where the instructions cause the processor to remove the graphical element for the poll event from the calendar view.

What is claimed is:

1. A system for displaying a graphical element associated with a poll in a calendar view, the system comprising:
a processor; and
memory including instructions which when executed by the processor, causes the processor to:
determine that a response from a user has not been provided to a poll event;
receive poll information associated with the poll event, the poll information identifying a period of time corresponding to when the poll event is open for receiving responses from the user;
determine a time slot in the calendar view of the user based on the period of time corresponding to when the poll event is open, and
cause a graphical element for the poll event to be displayed in the calendar view of the user at the determined time slot.

2. The system of claim 1, further comprising instructions, which when executed by the processor, causes the processor to:
determine that the time slot associated with the poll event corresponds to a time slot for an existing event; and
alter a graphical element associated with the existing event based on the poll information.

3. The system of claim 1, further comprising instructions, which when executed by the processor, causes the processor to:
receive an indication that the graphical element for the poll event has been selected;
cause a second graphical element to be displayed that solicits a response from the user; and
receive the response.

4. The system of claim 3, further comprising instructions, which when executed by the processor, causes the processor to:
remove the graphical element for the poll event from the calendar view or cause poll results information for the poll event to be displayed, the poll results information including the response.

5. The system of claim 1, further comprising instructions, which when executed by the processor, causes the processor to:
identify an organizational unit based on an existence of an assignment between the poll event and the organizational unit; and
determine one or more users belonging to the organizational unit, the one or more users including the user that has not provided the response to the poll event.

6. The system of claim 5, wherein a plurality of poll events are assigned to the organizational unit, a plurality of users are assigned to the organizational unit, and a plurality of organizational units are assigned to the poll event.

7. The system of claim 1, further comprising instructions, which when executed by the processor, causes the processor to:
cause a first graphical element for the poll event to be displayed when the polling event is open; and
cause a second different graphical element for the poll event to be displayed when the polling event is closed.

8. A method for displaying poll information in a calendar view depicting a plurality of events and a time slot associated with each of the plurality of events, the method comprising:
receiving poll information associated with a poll event, the poll information identifying a period of time corresponding to when the poll event is open for receiving responses and further indicating that a response to the poll event has not been received;
determining a time slot in the calendar view based on the plurality of events and the period of time corresponding to when the poll event is open; and
causing a graphical element for the poll event to be displayed in the calendar view at the determined time slot, the graphical element identifying a period of time corresponding to when the poll event is open for receiving responses from one or more users.

9. The method of claim 8, further comprising:
causing a first graphical element for the poll event to be displayed when the polling event is open; and
causing a second graphical element for the poll event to be displayed when the polling event is closed.

10. The method of claim 9, further comprising:
identifying an organizational unit to which a plurality of users belong based on an existence of an assignment between the poll event and the organizational unit; and
identifying a user belonging to the organizational unit, wherein the identified user includes a user that has not provided a response to the poll event.

11. The method of claim 8, further comprising:
removing the graphical element for the poll event from the calendar view.

12. The method of claim 8, further comprising:
determining that the time slot associated with the poll event corresponds to a time slot associated with an existing event; and
altering a graphical element associated with the existing event based on the poll information.

13. The method of claim 12, wherein the altered graphical element associated with the existing event indicates the existing event includes the poll event.

14. The method of claim 8, further comprising:
receiving a selection of the graphical element;
causing a graphical element that solicits a response from a user to be displayed;
receiving the response; and
displaying polling results information for the polling event, the polling results information including the response.

15. The method of claim 14, further comprising:
determining that the time slot based on the poll event corresponds to a time slot for an existing event; and
causing the graphical element and a graphical element for an existing event to be displayed simultaneously at the time slot in the calendar view.

16. A computer-readable storage medium including instructions, which when executed by a processor, cause the processor to:
receive an indication that a poll event has been created;
receive a plurality of responses for the poll event;
based on the plurality of received responses for the poll event, determine one or more users that have not provided a response; and
cause a graphical element for the poll event to be displayed in a calendar view of the one or more users that have not provided a response.

17. The computer-readable storage medium of claim 16, wherein the instructions cause the processor to determine a time slot based on one or more properties of the poll event.

18. The computer-readable storage medium of claim 17, wherein the one or more properties include a poll close time.

19. The computer-readable storage medium of claim 16, wherein the instructions cause the processor to:
receive an indication that the graphical element for the poll event has been selected;
cause a graphical element to be displayed that solicits a response from the one or more users; and
receive the response.

20. The computer-readable storage medium of claim 19, wherein the instructions cause the processor to remove the graphical element for the poll event from the calendar view.
